(19) United States
(12) Patent Application Publication
(10) Pub. No.: US 2020/0302408 A1
(43) Pub. Date: Sep. 24, 2020

(54) Recording Medium, Electronic Document Computer, Electronic Document System, Electronic Document Processing Method And Program

(71) Applicant: SKYCOM CO., LTD, Tokyo (JP)

(72) Inventors: Eri UENO, Miyazaki (JP); Katsuma TAKAHASHI, Miyazaki (JP); Syouichi HONDA, Miyazaki (JP); Nobuhiko SHIBATA, Miyazaki (JP)

(21) Appl. No.: 16/492,165

(22) PCT Filed: Mar. 9, 2017
(86) PCT No.: PCT/JP2017/009598

§ 371 Date: Sep. 9, 2019

(51) Int. Cl. G06Q 20/04; G06Q 20/36; G06Q 20/06

(52) U.S. Cl. CPC G06Q 20/0425; G06Q 20/065; G06Q 20/0457; G06Q 20/36

(57) ABSTRACT

The convenience of virtual currency transitions can be improved. The electronic document system 1 includes a plurality of electronic document terminals 20 that are capable to transmit and receive information on a virtual currency to and from each other. The sending electronic document terminal 20 includes an amount input module 220 that receives input of an amount billed in a virtual currency in a predetermined electronic document data 100 and an electronic document data transmitting and receiving module 240 that transmits the electronic document data 100 to a receiving electronic document terminal 20. The receiving electronic document terminal 20 includes an electronic document data transmitting and receiving module 240 that receives the transmitted electronic document data 100 and a payment module 250 that performs a process to pay the amount billed in a virtual currency associated with the electronic document data 100.

### BACKGROUND

### (a) Field

The present invention relates to a record medium, an electronic document computer, an electronic document system, a method for processing an electronic document, and a program.

### (b) Description of the Related Art

Virtual currencies are electronically transacted conventionally since physical ones may be, for example, lost.

For example, a computer that stores first transaction information including a first virtual currency and the identifier of a first user as a remittee in a transaction to transfer the first virtual currency; and second transaction information including a second virtual currency, the electronic signature of a second user as a remitter, and the identifier of a third user as a remittee in a second transaction to transfer the second virtual currency that is at least a part of the first virtual currency; requests a terminal device that is capable to verify the validity of transaction information to verify the validity of the second transaction information; verifies whether the second user is the first user or not based on the identifier of the first user and the electronic signature of the second user; and delivers approval information that indicating that the second transaction information was approved to a network if the verification is correct has been proposed (refer to Patent Document 1). According to the device of Patent Document 1, a virtual currency can be electronically transacted from a terminal connected with the computer through a network.

### CITATION LIST

### Patent Literature

Patent Document 1: JP 2016-218633A

### SUMMARY

However, the electronic transaction of a virtual currency that is described in Patent Document 1 are carried out by a wallet tool installed in a terminal which transfers a virtual currency and a terminal to which a virtual currency is transferred. To electronically transact a virtual currency, a wallet tool to transmit and receive a virtual currency should be installed in both the terminals of a remitter and a remittee. Therefore, the convenience of virtual currency transactions has been hampered.

In view of these problems, an objective of the present invention is to provide a record medium, an electronic document computer, an electronic document system, a method for processing an electronic document, and a program that are capable to improve the convenience of virtual currency transactions.

The first aspect of the present invention provides a record medium that stores data in which a virtual currency is associated with electronic document data allowing input in a partial input field with a fixed layout.

The second aspect of the present invention provides an electronic document computer including a virtual currency associating unit that associates a virtual currency with electronic document data allowing input in a partial input field with a fixed layout.

The third aspect of the present invention provides a program to cause a computer to function as a virtual currency associating unit that associates a virtual currency with electronic document data allowing input in a partial input field with a fixed layout.

According to the first to third aspects of the present invention, by associating a virtual currency with electronic document data, a virtual currency can be sent to a remittee who does not have a wallet, and the received electronic document data can be used as a wallet. Therefore, the convenience of virtual currency transaction can be improved.

Moreover, a conventional physical paper wallet has the risk for the loss caused by, for example, damage. According to the first to third aspects of the present invention, electronic document data plays a role as a wallet by associating a virtual currency with the electronic document data. This leads to enable backup, for example, in a cloud, so that the risk for the loss can be reduced. Moreover, according to the first to third aspects of the present invention, the size of a form, the number of characters, the style of a content to be included are more varied compared with a physical paper to enable the use for various purposes.

The fourth aspect of the present invention provides an electronic document system including a plurality of electronic document terminals that are capable to transmit and receive information on a virtual currency to and from each other, wherein

the sending electronic document terminal includes:

an amount input unit that receives input of an amount billed in the virtual currency in a predetermined electronic document data; and

an electronic document data transmission unit that transmits the electronic document data to a receiving electronic document terminal, and the receiving electronic document terminal includes:

an electronic document data receiving unit that receives the transmitted electronic document data; and

a payment unit that performs a process to pay the amount billed in a virtual currency associated with the electronic document data.

In the billing process, an invoice is issued from a remitter to a remittee and confirmed by the remittee, and then the amount billed under the invoice is transferred to the bank account specified in the invoice. According to the fourth aspect of the present invention, the billing amount can be paid in a virtual currency in the processing of electronic document data on an invoice to eliminate burdensome tasks of confirming an invoice and paying through a bank transfer.

The fifth aspect of the present invention provides an electronic document system including a plurality of electronic document terminals that are capable to transmit and receive information on a virtual currency to and from each other, wherein

the sending electronic document terminal includes:

an amount input unit that receives input of an amount to be handled as the virtual currency;

a virtual currency associating unit that associates the money amount of the virtual currency with a predetermined electronic document data; and

an electronic document data transmission unit that transmits the electronic document data to a receiving electronic document terminal.

According to the fifth aspect of the present invention, since a sending terminal associates a virtual currency with electronic document data that can be displayed on, for example, a general computer, a virtual currency can be provided even if a receiving terminal does not have a wallet to store a virtual currency.

The present invention can provide a record medium, an electronic document computer, an electronic document system, a method for processing an electronic document, and a program that are capable to improve the convenience of virtual currency transactions.

### BRIEF DESCRIPTION OF THE DRAWINGS

FIG. 1 is a diagram to illustrate an overview of the electronic document data 100 of a preferred embodiment of the present invention.

FIG. 2 is a diagram to illustrate an overview of the electronic document data 100 of a preferred embodiment of the present invention.

FIG. 3 is an overall configuration diagram of the electronic document system 1.

FIG. 4 is a diagram showing the relationships among the functional blocks and the functions of an electronic document terminal 20.

FIG. 5 is a flow chart of the process performed by a sending electronic document terminal 20 on demand for payment.

FIG. 6 is a flow chart of the process performed by a receiving electronic document terminal 20 on demand for payment.

FIG. 7 is a flow chart of the process performed by a sending electronic document terminal 20 for a gift.

FIG. 8 is a flow chart of the process performed by a receiving electronic document terminal 20 for a gift.

FIG. 9 is a diagram showing an example of the electronic document data 100 displayed on the input-output unit 23 of an electronic document terminal 20 on demand for payment.

FIG. 10 is a diagram showing an example of the electronic document data 100 displayed on the input-output unit 23 of an electronic document terminal 20 for a gift.

### DETAILED DESCRIPTION OF THE EMBODIMENTS

The most preferred embodiment of the present invention will be described below with reference to the attached drawings. However, this is illustrative only, and the technological scope of the present invention is not limited thereto.

### Overview of Electronic Document System

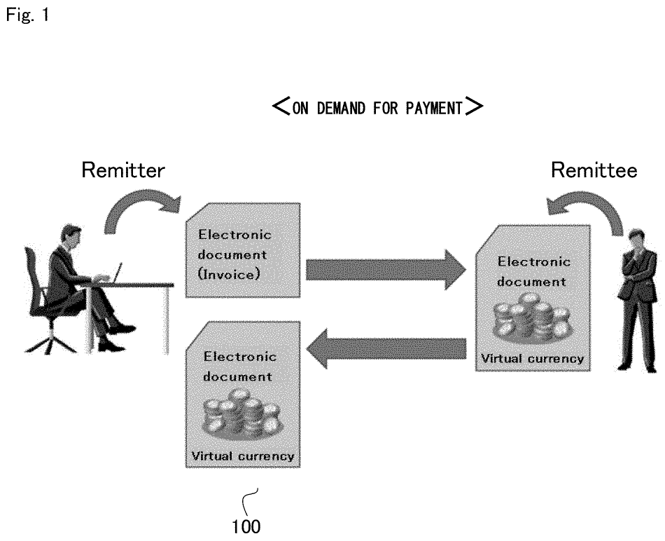

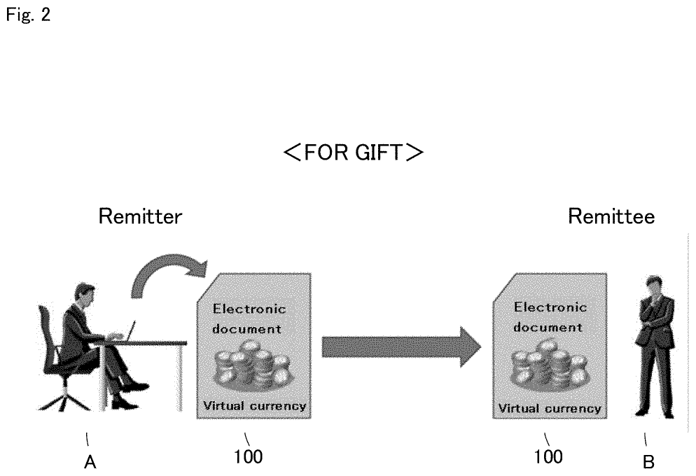

FIGS. 1 and 2 are diagrams to illustrate an overview of the electronic document data 100 of a preferred embodiment of the present invention. The overview of an embodiment to use the electronic document data 100 will be explained below with reference to FIG. 1. The electronic document data 100 is transmitted and received between a sending electronic document terminal and a receiving electronic document terminal in an electronic document system including a plurality of electronic document terminals that are capable to transmit and receive information on a virtual currency to and from each other.

The electronic document data 100 is capable to associate a virtual currency with versatile electronic document data allowing input in a partial input field with a fixed layout. In this embodiment, a “virtual currency” is, for example, a bit Coin®, which can be added to an electronic transaction and a physical medium through the Internet and used in exchange for articles and services like a legal currency.

In this embodiment, the user can, for example, create, edit, and view electronic document data with an application (hereinafter sometimes referred to as “electronic document app”) that is installed in an electronic document terminal and is capable to, for example, create, edit, and view electronic document data, associate a virtual currency with electronic document data 100, set a virtual currency wallet, view the transaction history of a virtual currency in a wallet, and, if necessary, affix the user's signature.

FIG. 1 shows an overview of the case where the electronic document data 100 is used as an invoice issued from the user A to the user B. When the electronic document data 100 is used as an invoice, the electronic document data 100 can include a billing amount input in a partial input field with the fixed layout of, for example, a general invoice. Furthermore, a public key that indicates the address of a virtual currency wallet to which the user A wants to send a billing amount is also associated. Furthermore, contents such as a photograph, a moving image, and a voice message can be placed in the fixed layout.

The user A creates electronic document data 100 used as an invoice with an electronic document app in an electronic document terminal and transmits the invoice to a receiving electronic document terminal operated by the user B.

The user B views the electronic document data 100 received from the sending electronic document terminal of the user A with an electronic document app in an receiving electronic document terminal and transfers the virtual currency based on the billing amount indicated by the electronic document data 100 to the associated receiving wallet.

Furthermore, the user B affixes the signature (for example, to prove payment paid) to the received electronic document data 100 and transmits it to the sending electronic document terminal operated by the user A if necessary.

FIG. 2 shows an overview of the case where the electronic document data 100 is used as a gift card that is a wallet storing a virtual currency issued as a gift from the user A to the user B. When the electronic document data 100 is used as a gift card, the electronic document data 100 can include a gift amount input in a partial input field with the fixed layout of, for example, a general gift card. Furthermore, the gift amount of a virtual currency is associated. Specifically, the electronic document data 100 is associated with a public key that indicates the address of a wallet storing the gift amount of a virtual currency and a private key to use the virtual currency stored in the wallet.

The user A creates electronic document data 100 to be used as a gift card with an electronic document app in an electronic document terminal and transmits it to a receiving electronic document terminal operated by the user B.

The user B views the electronic document data 100 received from the sending electronic document terminal of the user A with an electronic document app in an receiving electronic document terminal and ensures availability of the virtual currency stored in the wallet indicated by the electronic document data 100.

Conventionally, a wallet tool should be installed in both the sending and the receiving terminal to transmit and receive a virtual currency. According to the electronic document data 100 of this embodiment, by associating a virtual currency with versatile electronic document data that can be displayed on a general computer, a virtual currency can be sent to a remittee who does not have a wallet, and the received electronic document data 100 can be used as a wallet. Therefore, the convenience of virtual currency transaction can be improved.

Moreover, a conventional physical paper wallet has the risk for the loss caused by, for example, damage. However, the electronic document data 100 can be backed up as electronic data, for example, to store in a cloud so that the risk for the loss can be reduced. Moreover, the size of a form, the number of characters, and the style of a content to be included are more varied compared with a physical paper to enable the use for various purposes.

### System Configuration of Electronic Document System

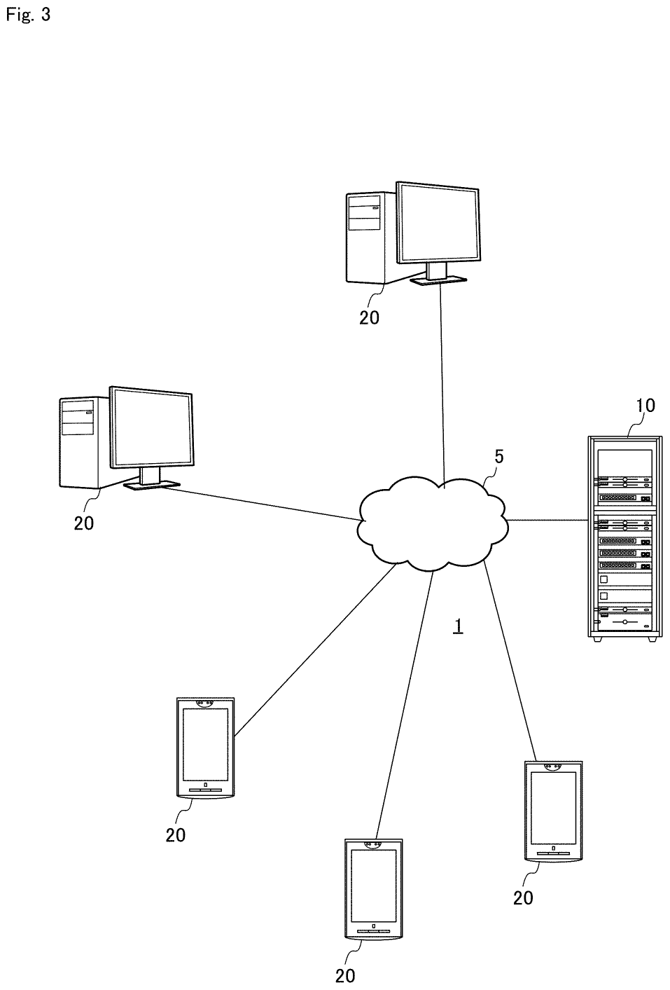

FIG. 3 is an overall configuration diagram of the electronic document system 1. In the electronic document system 1, a virtual currency computer 10 and a plurality of electronic document terminals 20 are communicatively connected with each other through a public line network 5 such as the Internet.

The virtual currency computer 10 is managed by a person who operates a virtual currency exchange where a user can buy a virtual currency in a legal currency and change a virtual currency to a legal currency. The virtual currency computer 10 may be made up of a plurality of computers to which different functions are distributed. The electronic document terminal 20 may be a general information terminal provided with a communication unit, which is an information device provided with the functions to be described later. For example, the terminal 30 may be a portable terminal such as a mobile phone, a smart phone, a net book terminal, a slate terminal, an electronic book terminal, an electronic dictionary terminal, a portable music player, or a portable content recording and reproducing device, or may be a stationary terminal such as a personal computer. Furthermore, the above-mentioned electronic document app is preferably installed in the electronic document terminals 20.

### Functions

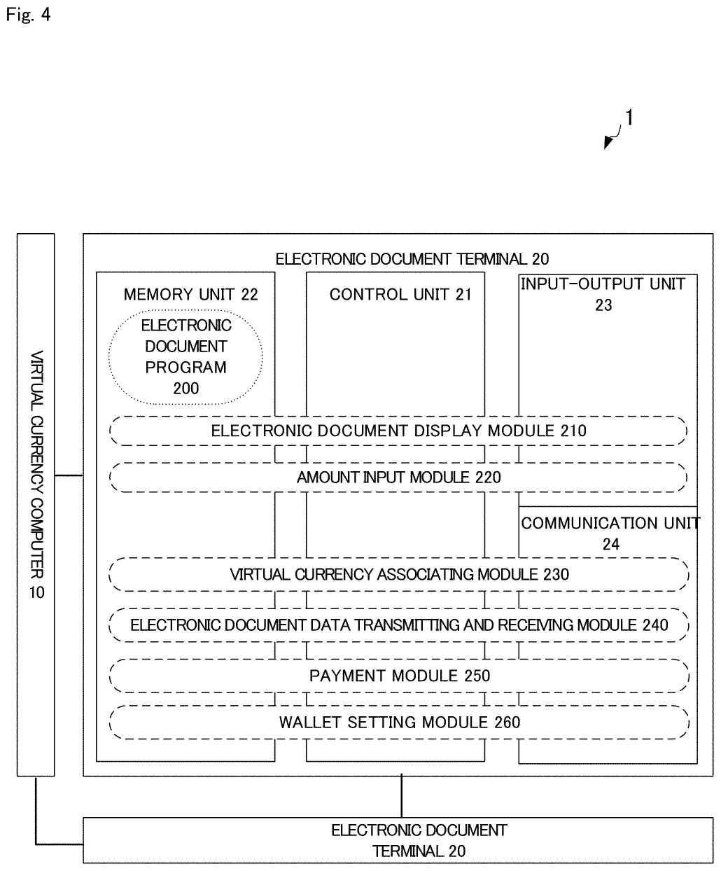

FIG. 4 is a diagram showing the relationships among the functional blocks and the functions of an electronic document terminal 20.

The electronic document terminal 20 includes a control unit 21 including a central processing unit (hereinafter referred to as “CPU”), a random access memory (hereinafter referred to as “RAM”), and a read only memory (hereinafter referred to as “ROM”); a memory unit 22 including a data storage unit such as a hard disk or a semiconductor memory; an input-output unit 23 including a display unit such as a touch panel or a display unit and an input unit such as a touch panel, a keyboard, or a mouse; and a communication unit 24 including a Wireless Fidelity or Wi-Fi® enabled device complying with, for example, IEEE 802.11, or a wireless device complying with the IMT-2000 standard such as the third or the fourth generation mobile communication system. The memory unit 22 stores data necessary for control of the electronic document terminal 20, such as an electronic document program 200 and electronic document data 100 (refer to FIGS. 1 and 2).

In the electronic document terminal 20, the control unit 21 reads an electronic document program 200 to achieve an electronic document display module 210 and an amount input module 220 in cooperation with the memory unit 22 and the input-output unit 23. In the electronic document terminal 20, the control unit 21 reads an electronic document program 200 to achieve a virtual currency associating module 230, an electronic document data transmitting and receiving module 240, a payment module 250, and a wallet setting module 260 in cooperation with the memory unit 22 and the communication unit 24.

### Processing in Sending Electronic Document Terminal on Demand for Payment

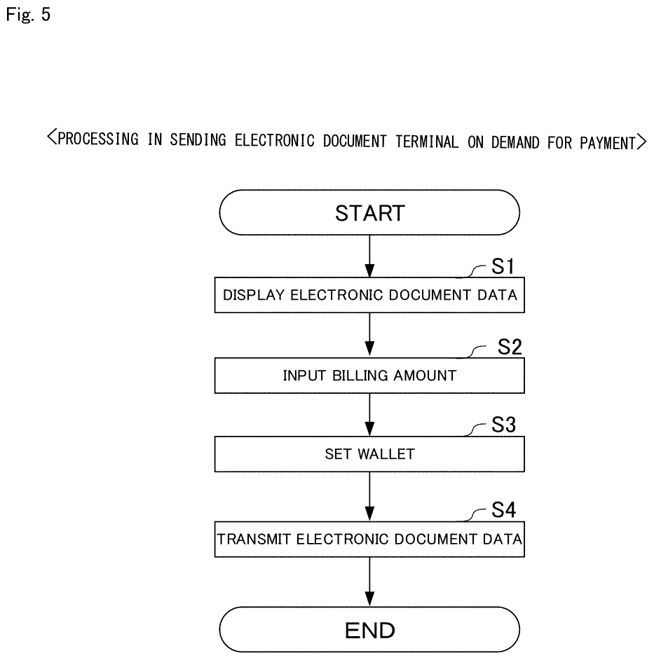

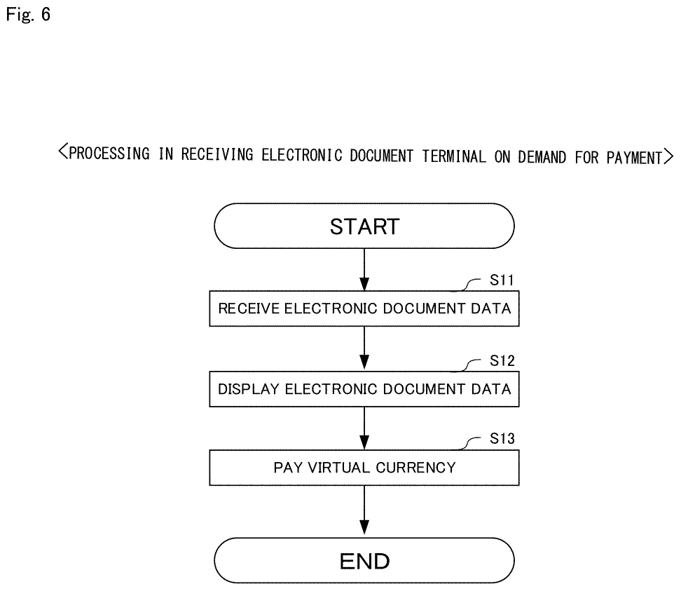

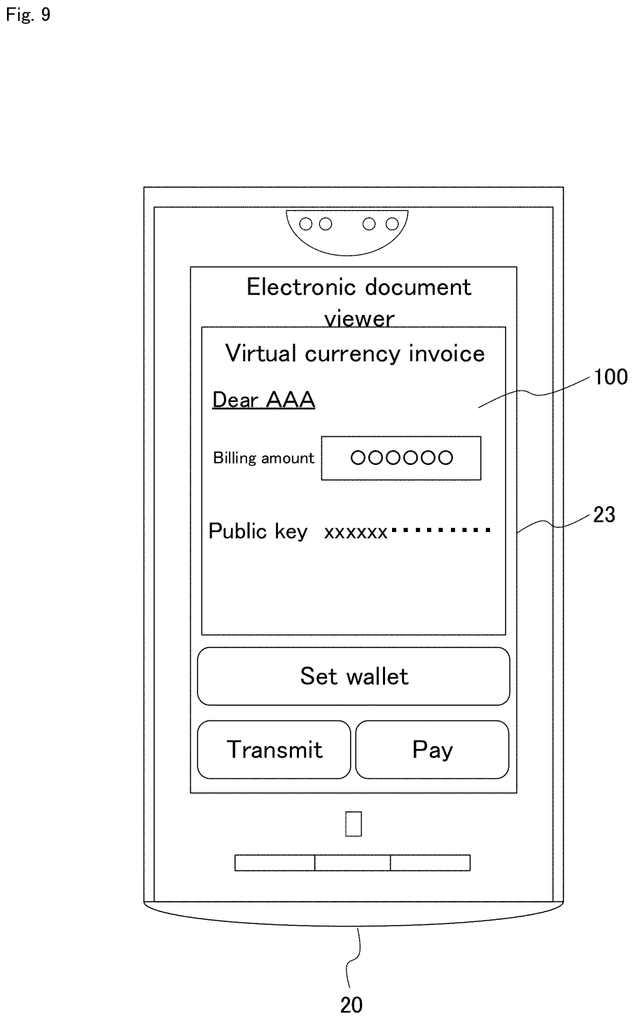

The processing in a sending electronic document terminal 20 when the electronic document data 100 is used as an invoice will be explained below. FIG. 5 is a flow chart of the process performed by a sending electronic document terminal 20 on demand for payment. FIG. 6 is a flow chart of the process performed by a receiving electronic document terminal 20 on demand for payment. FIG. 9 is a diagram showing an example of the electronic document data 100 displayed on the input-output unit 23 of an electronic document terminal 20 on demand for payment.

The process performed by a sending electronic document terminal 20 on demand for payment will be explained below with reference to FIG. 5. In the step S1, the electronic document display module 210 reads the electronic document data 100 with a fixed layout, for example, of a general invoice from the memory unit 12 and displays it on the input-output unit 23.

In the step S2, the amount input module 220 receives input of a billing amount in a partial input field of the electronic document data 100 displayed on the input-output unit 23 that is displayed in the step S1 (for example, the field next to “Billing amount” shown in FIG. 9) based on the user's operation from the input-output unit 23.

In the step S3, the wallet setting module 260 associates a public key that indicates the address of a virtual currency wallet with the electronic document data 100 displayed on the input-output unit 23 in the step S1. Specifically, the wallet setting module 260 associates a public key that indicates the address of a virtual currency wallet with the electronic document data 100 based on the user's operation from the input-output unit 23 (for example, from “Set wallet” button shown in FIG. 9).

In the step S4, the electronic document data transmitting and receiving module 240 transmits the electronic document data 100 in which a billing amount is input in the step 2 based on the user's operation from the input-output unit 23 (for example, from “Transmit” button shown in FIG. 9) and with which a public key that indicates the address of a virtual currency wallet in the step S3 is associated to a receiving electronic document terminal 20.

The process performed by a receiving electronic document terminal 20 on demand for payment will be explained below with reference to FIG. 6. In the step S11, the electronic document data transmitting and receiving module 240 receives the electronic document data 100 transmitted from a sending electronic document terminal 20 and stores it in the memory unit 12.

In the step S12, the electronic document display module 210 reads the electronic document data 100 received in the step S11 from the memory unit 12 and displays it on the input-output unit 23.

In the step S13, the payment module 250 transfers a virtual currency that corresponds to the billing amount, based on the user's operation from the input-output unit 23 (for example, from “Pay” button shown in FIG. 9), from the previously set virtual currency wallet to the address of the virtual currency wallet indicated by the public key in the receiving electronic document terminal 20 based on the billing amount input in the electronic document data 100 and the public key associated with the electronic document data 100.

If the previously set virtual currency wallet does not exist in the receiving electronic document terminal 20, the user may operate, for example, “Set wallet” button shown in FIG. 9 to set a virtual currency wallet and store a virtual currency acquired by accessing the virtual currency computer 10 in the set virtual currency wallet. Then, the process of the step S13 may be performed.

### Processing in Sending Electronic Document Terminal for Gift

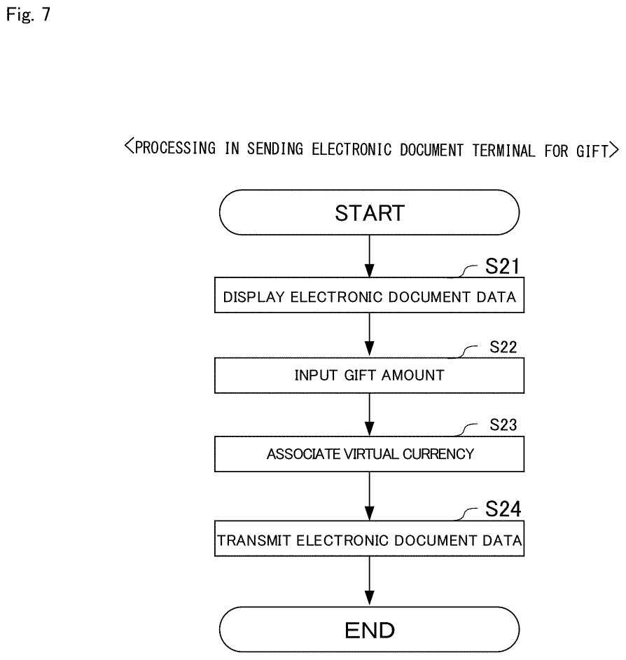

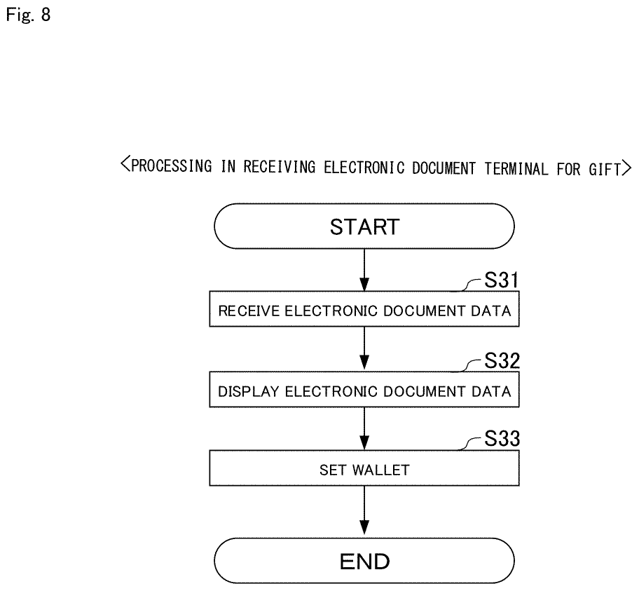

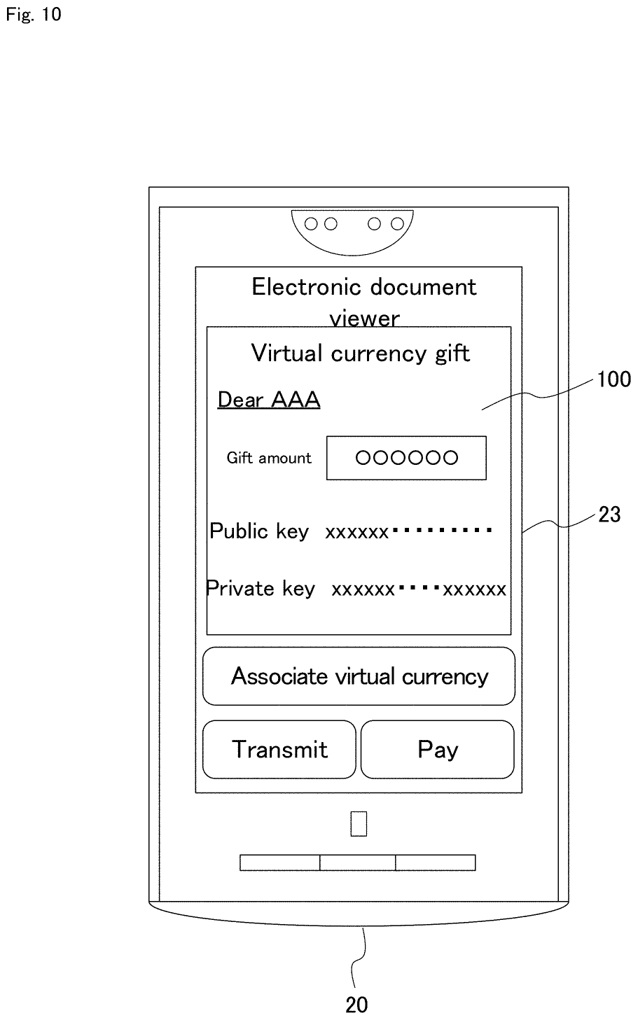

The processing in a sending electronic document terminal 20 when the electronic document data 100 is used as a gift card will be explained below. FIG. 7 is a flow chart of the process performed by a sending electronic document terminal 20 for a gift. FIG. 8 is a flow chart of the process performed by a receiving electronic document terminal 20 for a gift. FIG. 10 is a diagram showing an example of the electronic document data 100 displayed on the input-output unit 23 of an electronic document terminal 20 for a gift.

The process performed by a sending electronic document terminal 20 for a gift will be explained below with reference to FIG. 7. The terms “gift” and “gift card” herein may be a predetermined virtual currency given to any person, for example, in the form of a present, a congratulatory money, and a condolence money. In the step S21, the electronic document display module 210 reads the electronic document data 100 with the fixed layout, for example, of a general gift card from the memory unit 12 and displays it on the input-output unit 23. Furthermore, contents such as a still image, a moving image, and a voice message may be placed in the fixed layout.

In the step S22, the amount input module 220 receives input of a gift amount in a partial input field of the electronic document data 100 displayed on the input-output unit 23 that is displayed in the step S21 (for example, the field next to “Gift amount” shown in FIG. 10) based on the user's operation from the input-output unit 23.

In the step S23, the virtual currency associating module 230 associates a public key that indicates the address of a virtual currency wallet with the electronic document data 100 displayed on the input-output unit 23 in the step S21, stores a virtual currency that corresponds to the gift amount input in the wallet in the step S22, and associates the virtual currency stored in the wallet with the electronic document data 100. Specifically, the virtual currency associating module 230 associates a public key that indicates the address of a virtual currency wallet and a private key for the use of the virtual currency stored in the wallet with the electronic document data 100 based on the user's operation from the input-output unit 23 (for example, from “Associate virtual currency” button shown in FIG. 10).

Furthermore, the virtual currency associating module 230 may set the validity date for use of the wallet associated with the electronic document data 100 and display the validity date in the fixed field of the electronic document data 100.

In the step S24, the electronic document data transmitting and receiving module 240 transmits the electronic document data 100 in which a gift amount is input in the step 22 based on the user's operation from the input-output unit 23 (for example, from “Transmit” button shown in FIG. 10) and with which a public key that indicates the address of a virtual currency wallet and a private key for the use of the virtual currency stored in the wallet are associated in the step S23 to a receiving electronic document terminal 20.

In the example shown in FIG. 10, a public key that indicates the address of a virtual currency wallet and a private key for the use of the virtual currency stored in the wallet are associated with one electronic document data 100. However, the invention is not limited to the example. The private key may be associated with an electronic document data 100 different from the one associated with the public key and transmitted to a receiving electronic document terminal 20 at a timing different from the timing of when the electronic document data 100 with which the public key is associated.

The process performed by a receiving electronic document terminal 20 for a gift will be explained below with reference to FIG. 8. In the step S31, the electronic document data transmitting and receiving module 240 receives the electronic document data 100 transmitted from a sending electronic document terminal 20 and stores it in the memory unit 12.

In the step S32, the electronic document display module 210 reads the electronic document data 100 received in the step S31 from the memory unit 12 and displays it on the input-output unit 23.

In the step S33, the wallet setting module 260 ensures availability of the virtual currency stored in the wallet in the receiving electronic document terminal 20 based on the public key that indicates the address of a virtual currency wallet associated with the electronic document data 100 and the private key for the use of the virtual currency stored in the wallet that are received in the step S31. The wallet setting module 260 may display the balance and the transaction history of the set wallet on the input-output unit 23, for example, based on user's operation.

Therefore, the user who operates a receiving electronic document terminal 20 can use the virtual currency associated with the electronic document data 100 transmitted from a sending electronic document terminal 20 and move the virtual currency to a wallet that the user has already owned.

To achieve the means and the functions that are described above, a computer (including a CPU, an information processor, and various terminals) reads and executes a predetermined program. For example, the program is provided in the form recorded in a computer-readable medium such as a flexible disk, CD (e.g., CD-ROM), or DVD (e.g., DVD-ROM, DVD-RAM). In this case, a computer reads a program from the record medium, forwards and stores the program to and in an internal or an external storage, and executes it. The program may be previously recorded in, for example, a storage (record medium) such as a magnetic disk, an optical disk, or a magnetic optical disk and provided from the storage to a computer through a communication line.

The embodiments of the present invention are described above. However, the present invention is not limited to the above-mentioned embodiments. The effect described in the embodiments of the present invention is only the most preferable effect produced from the present invention. The effects of the present invention are not limited to those described in the embodiments of the present invention.

### DESCRIPTION OF REFERENCE NUMBERS

1 Electronic document system
5 Public line network
10 Virtual currency computer
12 Memory unit
20 Electronic document terminal
21 Control unit
22 Memory unit
23 Input-output unit
24 Communication unit
100 Electronic document data
200 Electronic document program
210 Electronic document display module
220 Amount input module
230 Virtual currency associating module
240 Electronic document data transmitting and receiving module
250 Payment module
260 Wallet setting module

1. (canceled)

2. (canceled)

3. (canceled)

4. An electronic document system comprising a plurality of electronic document terminals that are capable to transmit and receive information on a virtual currency to and from each other, wherein
the sending electronic document terminal includes:
an amount input unit that receives input of an amount billed in the virtual currency in a versatile electronic document data allowing to be created, edited, and viewed by an installed application and allowing input in a partial input field with a fixed layout;
a wallet setting unit that associates a public key that indicates the address of the virtual currency wallet with the electronic document data based on user's operation;
an electronic document data transmission unit that transmits the electronic document data in which the amount billed is input by the amount input unit and with which the public key is associated by the wallet setting unit to a receiving electronic document terminal, the receiving electronic document terminal includes:
an electronic document data receiving unit that receives the transmitted electronic document data; and
a payment unit that transfers the virtual currency that corresponds to the amount billed, based on user's operation from the previously set virtual currency wallet to the address of the virtual currency wallet indicated by the public key in the receiving electronic document terminal based on the amount billed input in the electronic document data and the public key associated with the electronic document data.

5. An electronic document system comprising a plurality of electronic document terminals that are capable to transmit and receive information on a virtual currency to and from each other, wherein
the sending electronic document terminal includes:
an amount input unit that receives input of an amount to be handled as the virtual currency in a versatile electronic document data allowing to be created, edited, and viewed by an installed application and allowing input in a partial input field with a fixed layout;
a virtual currency associating unit that associates a public key that indicates the address of a virtual currency wallet with the electronic document data, stores the virtual currency that corresponds to the amount handled received by the amount input unit, and associates the virtual currency stored in the wallet with the electronic document data; and
an electronic document data transmission unit that transmits the electronic document data to a receiving electronic document terminal.

6. A method for processing an electronic document, the method being executed by an electronic document system comprising a plurality of electronic document terminals that are capable to transmit and receive information on a virtual currency to and from each other, comprising the steps of:
receiving input of an amount billed in the virtual currency in a versatile electronic document data allowing to be created, edited, and viewed by an installed application and allowing input in a partial input field with a fixed layout in the sending electronic document terminal;
associating a public key that indicates the address of the virtual currency wallet with the electronic document data based on user's operation;
transmitting the electronic document data in which the amount billed is input by the step of receiving input an amount billed and with which the public key is associated by the step of associating a public key to a receiving electronic document terminal from the sending electronic document terminal;
receiving the transmitted electronic document data in the receiving electronic document terminal; and
transferring the virtual currency that corresponds to the amount billed, based on user's operation from the previously set virtual currency wallet to the address of the virtual currency wallet indicated by the public key in the receiving electronic document terminal based on the amount billed input in the electronic document data and the public key associated with the electronic document data in the receiving electronic document terminal.

7. A method for processing an electronic document, the method being executed by an electronic document system comprising a plurality of electronic document terminals that are capable to transmit and receive information on a virtual currency to and from each other, comprising the steps of:
receiving input of an amount to be handled as the virtual currency in a versatile electronic document data allowing to be created, edited, and viewed by an installed application and allowing input in a partial input field with a fixed layout in the sending electronic document terminal;
associating a public key that indicates the address of a virtual currency wallet with the electronic document data, stores the virtual currency that corresponds to the amount received in the step of receiving input of the amount handled, and associating the virtual currency stored in the wallet with the electronic document data in the sending electronic document terminal; and
transmitting the electronic document data to a receiving electronic document terminal from the sending electronic document terminal.
